(19) United States
(12) Patent Application Publication
(10) Pub. No.: US 2005/0284009 A1
(43) Pub. Date: Dec. 29, 2005

(54) Advertising system

(76) Inventors: Craig Lazarus, Double Bay (AU); Craig Wunsh, Double Bay (AU)

Correspondence Address: SEYFARTH SHAW LLP, 55 EAST MONROE STREET, SUITE 4200, CHICAGO, IL, 60603-5803, US

(21) Appl. No.: 10/876,137

(22) Filed: Jun. 23, 2004

(51) Int. Cl. G09F 1/00

(52) U.S. Cl. 40/358

(57) ABSTRACT

An advertising system including at least one tabletop, the tabletop includes advertising material viewable from a position above the tabletop and at least one food carrying tray through which the advertising material may be viewed when the tray is resting on the tabletop.

### TECHNICAL FIELD

This invention relates to an advertising system.

### BACKGROUND TO THE INVENTION

It has been tried to provide tables in public eating areas that are provided with a viewing window in the top of the table through which advertising material can be viewed. The table includes means by which the advertising material can be removed and replaced with an alternative advertisement. The advertising material is typically provided in the form of a sheet of paper bearing various advertising messages. Examples of tables of this type are described in published French patent FR2276649 and published Australian patent application 200231466.

In public eating areas it is usual for people to bring their food or drinks to a table of their choice by carrying them on a tray. The tray is then set down on the table and a person may leave their food or drink on the tray and consume the food or drink from the tray, or they may remove their food and drink from the tray and leave the tray on the table in front of them. In either case, the tray obscures the advertising material from view, either partially or completely. Thus, the impact of the advertising material on that person is diminished.

### SUMMARY OF THE INVENTION

In a first aspect the present invention provides an advertising system including at least one tabletop, the tabletop includes advertising material viewable from a position above the tabletop; and
at least one substantially transparent food carrying tray through which the advertising material may be viewed when the tray is resting on the tabletop.

### BRIEF DESCRIPTION OF THE DRAWINGS

An embodiment of the present invention will now be described, by way of example only, with reference to the accompanying drawings, in which:

FIG. 1 is a perspective view of a tabletop bearing advertising; and

FIG. 2 is a perspective view of an embodiment of the present invention.

### DETAILED DESCRIPTION OF THE PREFERRED EMBODIMENT

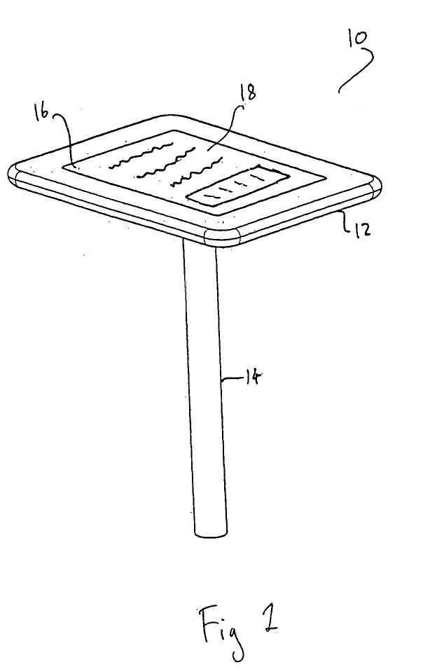

Referring to FIG. 1 a table 10 is shown including a tabletop 12 and a supporting stand 14. The tabletop includes a viewing window 16 through which advertising material 18 may be viewed. The advertising material 18 is held within the table and may be changed as and when desired.

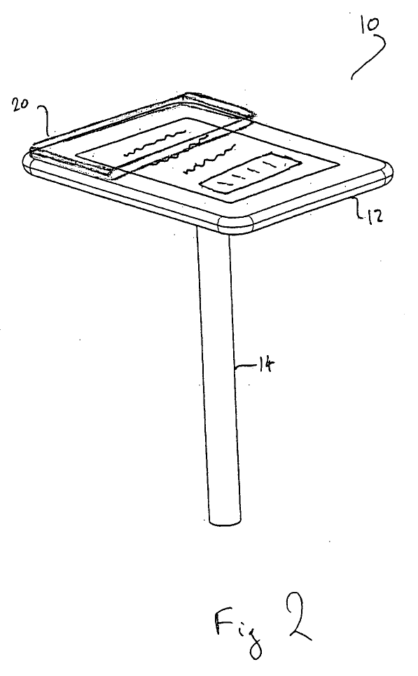

Referring to FIG. 2, a transparent food carrying tray 20 is shown resting on the table 10. Food carrying tray includes a base portion, and four upstanding walls around the perimeter of the tray. The tray is moulded in one piece from transparent plastic. When tray 20 is resting on the table 10, the advertising material 18 is not obscured from view.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. An advertising system including:
at least one tabletop, the tabletop includes advertising material viewable from a position above the tabletop; and
at least one food carrying tray through which the advertising material may be viewed when the tray is resting on the tabletop.

2. An advertising system according to claim 1 wherein the tray is substantially entirely transparent.

3. An advertising system according to claim 1 wherein the tray is moulded in one piece from transparent plastic.

4. An advertising system according to claim 2 wherein the tray is moulded in one piece from transparent plastic.
